(19) United States
(12) Patent Application Publication
(10) Pub. No.: US 2012/0275756 A1
(43) Pub. Date: Nov. 1, 2012

(54) ELECTRONIC HANDHELD AUDIO/VIDEO RECEIVER AND LISTENING/VIEWING DEVICE

(75) Inventors: Tazwell L. Anderson, JR., Atlanta, GA (US); Geoffrey L. Anderson, Atlanta, GA (US); Mark A. Wood, Boca Raton, FL (US)

(73) Assignee: IMMERSION ENTERTAINMENT LLC, Atlanta, GA (US)

(21) Appl. No.: 13/478,756

(22) Filed: May 23, 2012

Related U.S. Application Data
(63) Continuation of application No. 10/630,069, filed on Jul. 30, 2003, now abandoned.
Application No. 10/630,069 is a continuation-in-part of application No. 09/837,128, filed on Apr. 18, 2001, now abandoned.

(51) Int. Cl. H04N 7/18; H04N 5/77

(52) U.S. Cl. 386/223; 348/159; 348/E07.085; 386/E05.069

(57) ABSTRACT

A handheld device in connection with an audio/video system receives and processes video and/or audio signals and displays images to a user or produces sound audible to user. The handheld device may provide for capturing and storing images or continuous video. The handheld also may provide for enhanced viewing of the event using an optics system.

### CROSS REFERENCE TO RELATED APPLICATIONS

This application is a continuation of U.S. patent application Ser. No. 10/630,069 filed Jul. 30, 2003 which is a continuation-in-part and claims priority to U.S. patent application Ser. No. 09/837,128 filed Apr. 18, 2001 for “ELECTRONIC HANDHELD AUDIO/VIDEO RECEIVER AND LISTENING VIEWING DEVICE,” which is hereby incorporated by reference herein in its entirety.

### BACKGROUND OF THE INVENTION

The present invention relates generally to a device for processing video and/or audio signals and for displaying images and producing sounds based on the processed video and/or audio signals.

Video and/or audio signals are generated from a plurality of sources during many events. An “event” is any occurrence viewed by a spectator. For example, at a football game or other type of event (e.g., sporting event, automobile race, concert, circus, etc.), television crews usually position cameras and microphones at various locations at that event (e.g., various locations in a stadium or around a racetrack). As used herein, “stadium” refers to any non-movable structure having a large number of seats (e.g., thousands of seats), wherein an event occurs such that spectators sitting at seats (e.g., seats within a close proximity of the event) can view and hear the event, and includes non-enclosed non-movable structures (e.g., buildings along a road race and from which spectators can view the race). As another example, different cameras and microphones may be positioned at different locations at an event, such as an automobile race (e.g., camera and microphone positioned at different turns at the racetrack and/or in the crew pit). At these events, the television crews generate audio and video signals defining views and sounds of the event from various perspectives (e.g., end-zone and sideline view of football game or view of second and third turns at a racetrack).

One of the video signals and one of the audio signals are usually selected at a television production facility to form a combined audio/video signal. The signal is then modulated and transmitted so that users having a television can receive the signal via the television (e.g., receive an RF signal). The television demodulates the combined signal and displays an image defined by the video signal on a display screen and reproduces the sounds defined by the audio signal via speakers. Therefore, the sights and sounds of an event, such as a sporting event or game, can be viewed and heard via the television.

However, spectators viewing and/or hearing the sights and sounds of, for example, a game via televisions are not usually given the opportunity to select which video and/or audio signals are modulated and transmitted for viewing. Therefore, the spectator is only able to receive the signals modulated and transmitted to the television as selected at the production facility (e.g., selected by a director viewing different views on multiple screens), even though the spectator may prefer to receive other signals that are generated at the game. This may include spectators watching the event at home on a television or spectators viewing a portable television at the event being viewed both live and on the portable television.

Further, spectators that attend the event are usually given more options to view and/or hear the sights and sounds of the event from different perspectives. For example, one or more monitors are sometimes located at one or more locations in the stadium. Each monitor within the stadium receives one of the aforementioned video signals and displays an image defined by the received video signal to the spectators viewing the monitor. However, the monitor does not always display a desirable perspective with respect to each spectator in the stadium, and the monitor is often not located in a convenient location for many of the spectators. Some of the monitors also may have limited access for viewing by specific spectators. In many instances, spectators often must leave their seats (or other locations) in the stadium and go to a location where the spectators, along with other spectators, can view the monitor displaying the desired perspective. The spectators viewing the monitor often do not have control over the image displayed by the monitor.

In order to enhance the experience for spectators at events, spectators may view and/or observe the event using devices such as, for example, binoculars, cameras, portable radios and camcorders. These devices used by attendees of, for example, entertainment and sports events, enhance the live experience of attending the event and/or to allow for recording, via photographs or video, the event attended for later viewing. For example, event attendees may take binoculars to an event for close-up viewing of the action at the event. Event attendees may also carry radios to listen to live play-by-play broadcast of, for example, sporting events at which they are attending. Further, these radios may be used to listen to other events, for example to stay up to date with the action at other events taking place at the same time (e.g., watching a football game live and listening to another football game on the radio). Additionally, event attendees may bring a camera to take photographs of the event, for example, when attending a football game or automobile race. Images and sounds of the event also may be video recorded by camcorders brought to the event by event spectators.

An attendee or spectator of an event must use numerous different devices to view, listen, photograph or record, for example the action at the event, which is often burdensome on the event attendee (e.g., carry several different devices to use the individual functions from each). These devices also fail to provide event attendees and spectators with different viewing options, including viewing an event from different perspectives not otherwise visible to the spectator. Thus, these individual devices fail to provide flexibility in operation and may fail to provide satisfactory performance when used at an event.

### SUMMARY OF THE INVENTION

Various embodiments of the present invention provide a device and more specifically a portable (e.g., handheld) viewer/receiver/recorder device that may be used by event attendees or spectators. The device is configured to receive a plurality of audio and video signals defining different sounds and views associated with an event, and selectable by a user. Further, the device is configured to record and/or capture images and sounds of the event, or additionally, enhance the viewing of such event.

Specifically, various embodiments of the present invention include a handheld device having a digital processing system to receive video and audio signals for use in displaying images of an event based upon the received video signals and producing sounds of the event based on the received audio signals. The handheld device is configured to allow for enhanced viewing (e.g., magnification using binocular functions) or recording of the event, or portions of the event. The digital processing system receives one or more of video, optical and audio signals from a plurality of sources, which may be selected by the user, and allows for viewing and hearing event content (e.g., live images and sounds of the event or video/data from other sources or events) at the event or recording the event content, or a portion thereof, for later viewing and listening (e.g., video or still images), thereby allowing the user to view live event content or recorded event content.

In the various embodiments, the device may be used to view enhanced images of the event by holding the handheld device to the user's face (e.g., binocular capability) or may be held a distance from the user's face for viewing and listening to the event and/or other video/audio. The handheld device may include additional functions or components for use when viewing an event. For example, the handheld device may incorporate an integrated light shield/shroud to block ambient light that can interfere with the user's ability to view an image displayed by the handheld device. The light shield/shroud may be configured such that a user may operate the device while wearing eyeglasses or sunglasses.

Specifically, in one embodiment, a portable device includes a receiver for receiving signals relating to an event, a display configured to provide event content for viewing based upon at least one of the video signals selected by a user, and a memory component configured to store event content. The receiver also may be configured to receive audio signals relating to the event, with the portable device further including an audio component configured to provide event content for listening based upon at least one of the audio signals selected by a user. The portable device may include a processor for controlling operation in a plurality of modes (e.g., a video or television viewer, radio, binocular viewer, digital camera or camcorder). The portable device further may include an optics system having first and second lens assemblies provided as part of a housing to capture images of the event and configured to provide a plurality of magnified modes of operation. The receiver also may be configured to receive the video and audio signals only when authorized.

In another embodiment, a portable event entertainment device includes a receiver for receiving video and audio signals relating to an event, with the video and audio signals defining images and sounds of the event and transmitted for reception at the event. The portable event entertainment device also includes a display configured to allow viewing the images of the event based upon at least one received video signal selected by a user and an audio system configured to allow listening to the sounds of the event based upon at least one received audio signal selected by a user. The portable event entertainment device further includes an optics system configured to allow viewing of the event and a processor for controlling operation in a plurality of modes (e.g., video or television viewer, radio, binocular viewer, digital camera and camcorder). The portable event entertainment device additionally includes a memory component configured to store images and sounds of the event.

### BRIEF DESCRIPTION OF THE DRAWINGS

FIG. 1 is a block diagram of one exemplary embodiment of a video/audio receiving system constructed according to the principles of the present invention;

FIG. 2 is a block diagram of one exemplary embodiment of an image display system of FIG. 1;

FIG. 3 is a block diagram of another exemplary embodiment of a video/audio receiving system constructed according to the principles of the present invention;

FIG. 4 is a three-dimensional side view of an exemplary embodiment of a handheld device for implementing the video/audio receiving system of FIG. 1;

FIG. 5 is a top view of one exemplary embodiment of the exemplary handheld device shown in FIG. 4;

FIG. 6 is a three-dimensional front view of the exemplary embodiment of the handheld device depicted in FIG. 4; and

FIG. 7 is a perspective view of another embodiment of a handheld device constructed according to principles of the present invention.

### DETAILED DESCRIPTION OF PREFERRED EMBODIMENTS

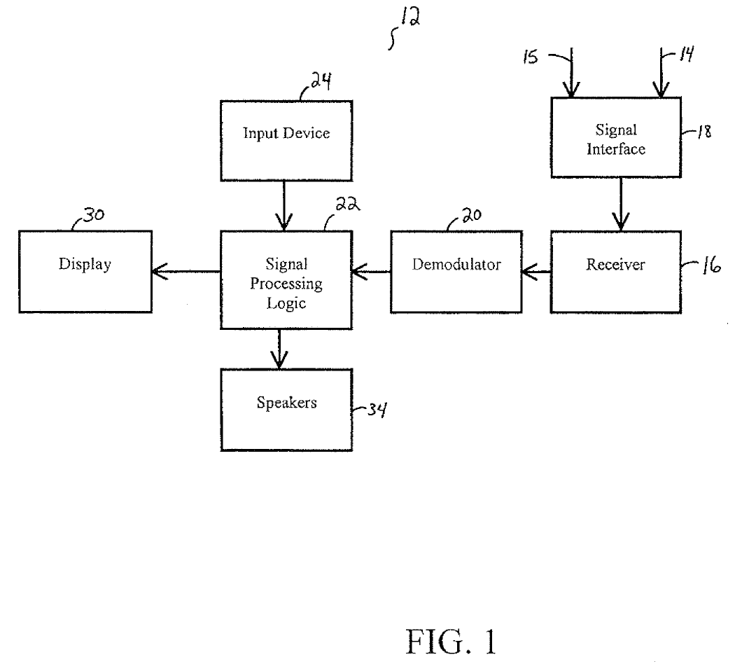

FIG. 1 illustrates an exemplary embodiment of a video/audio receiving system 12 constructed according to the principles of the present invention. At least one video signal 14 and at least one audio signal 15 are received by a receiver 16 via a signal interface 18. Each of the video signals 14 defines, for example, a view of an event, such as from different perspectives. For example, the video signals 14 may be generated by different video cameras located at different locations at an event (e.g., positioned at different locations around a stadium or racetrack, at various holes at a golf tournament, close-up to or on the stage at a concert). Furthermore, each of the audio signals 15 defines different sounds associated with an event. For example, at least one of the audio signals 15 may be generated from a microphone located close to the sideline of a game or in one of the helmets of one of the players of the game (e.g., the helmet of a football player) such that the audio signal defines sounds from the participants in the game, or may be generated from a microphone in a pit area of a racetrack with the audio signal defining sounds from the pit crew. Alternatively, at least one of the audio signals 15 may define the comments of television commentators, and at least one of the audio signals may define the comments of radio commentators. Further, and for example, the video signals 14 may define live television broadcasts of the event.

It should be noted that the video and audio signals 14 and 15 may be received from a plurality of different sources (e.g., local broadcast, closed circuit broadcast at the event, cable television, satellite broadcast and the Internet) and define content related to the event being attended or another event. It should also be noted that the video and audio signals 14 and 15 are not limited to providing images and sounds of one event or the event being attended. Event content defined by the video and audio signals 14 and 15 and/or other signals (e.g., data signals) may include, but is not limited to, audio/video from other events, public television broadcasts, cable television broadcasts, satellite broadcasts, Internet data, such as, for example, emails or news, and interactive media or data, such as, for example, trivia contests or other games.

In particular, at least one of the audio and one of the video signals may be transmitted as a single combined signal from an audio/video system such as described in U.S. Pat. No. 6,578,203 entitled “Audio/Video Signal Distribution System for Head Mounted Displays,” the entire disclosure of which is hereby incorporated herein by reference. Additionally, one or more of the video and/or audio signals may be wireless, in which case, the signal interface 18 may include one or more antennas for receiving the wireless signals. However, various other types of signal interfaces 18 are contemplated. For example, the signal interface 18 may be a cable or other type of wired or signal transmission apparatus. Any type of wireless and/or non-wireless technique may be used to transmit signals to receiver 16 via the signal interface 18.

Some of the video and audio signals 14 and 15 may be unmodulated when transmitted to the receiver 16 through the signal interface 18 and, therefore, do not need to be demodulated by the system. However, some of the video signals 14 and/or audio signals 15 may be modulated when received by the receiver 16, and, therefore, may need to be demodulated by the system 12. For example, at least one of the audio signals 15 defining the comments of radio commentators may be modulated as a radio signal for transmission to radios located at or away from the event, and at least one of the video signals 14 may be modulated as a television signal for transmission to televisions located at or away from the event. Therefore, as shown in FIG. 1, the a video/audio receiving system 12 preferably includes a demodulator 20 configured to demodulate modulated video signals 14 and/or audio signals 15 received by the receiver 16 through the signal interface 18.

Once demodulated, if necessary, the video and audio signals 14 and 15 are processed by signal processing logic 22, which selects and conditions the signals 14 and 15. Specifically, the signal processing logic 22 selects, based on inputs from the user as described herein, one or more of the video signals 14 and one or more of the audio signals 15. It should be noted that the signal processing logic 22 may be implemented via hardware, software, or a combination thereof. Further, the signal processing logic 22 may include one or more filters for filtering out unselected signals 14 and 15. After selecting one of the video and audio signals 14 and 15, the signal processing logic 22 conditions the selected video signals 14 such that they are compatible with an image display system 30, and the signal processing logic 22 conditions the selected audio signals 15 such that they are compatible with speakers 34. The signal processing logic 22 then transmits the conditioned audio signals 15 to the speakers 34, which converts the conditioned audio signals 15 into sound. The signal processing logic 22 also transmits the conditioned video signals 14 to the image display system 30, which displays the image defined by the conditioned video signals 14 according to techniques known in the art. It should be noted that the processing performed by the signal processing logic 22 may be provided as described in U.S. Pat. No. 6,578,203.

Further, an input device 24, which may include, for example, one or more buttons, knobs, dials, or other types of switches, may be used to provide the inputs for the processing performed by the signal processing logic 22. It should be noted that these exemplary input devices 24 may be interchanged, modified or replaced with other input devices as desired or needed. By controlling the components of the input device 24, the user may control various aspects of the processing performed by the signal processing logic 22, including which video signals 14 are selected for viewing, as well as which audio signals 15 are heard and the volume of the audio signals 15.

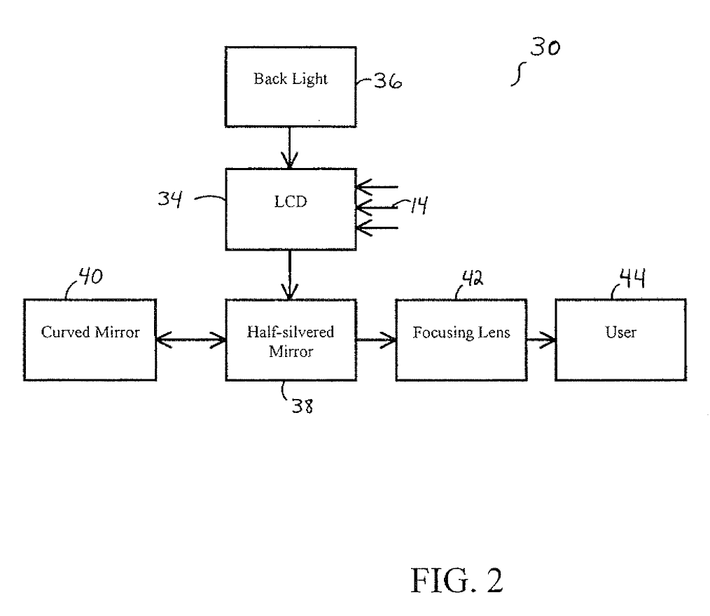

FIG. 2 illustrates an exemplary embodiment of an image display system 30 constructed according to the principles of the present invention. Specifically, a processed video signal 14 is displayed onto a Liquid Crystal Display (LCD) 34. The LCD 34 may be lit from the back via a backlight 36, with the light shining through the LCD 34, creating an image on the other side of the LCD 34. On the opposite side of the LCD 34 from the backlight 36, a distance from the LCD 34, is a half-silvered mirror 38. The half-silvered mirror 38 is set at an approximately forty-five degree angle from the LCD 34. The image reflects off the half-silvered mirror 38 onto a separate curved mirror 40 set a distance away from the half-silvered mirror 38. The curved mirror 40 magnifies the image. The magnified image reflects off of the curved mirror 40, back to the half-silvered mirror 38. The magnified image passes through the half-silvered mirror 38 to a lens 42 located on the opposite side of the half-silvered minor 38 from the curved mirror 40. The magnified image passes through the lens 42, which focuses the magnified image.

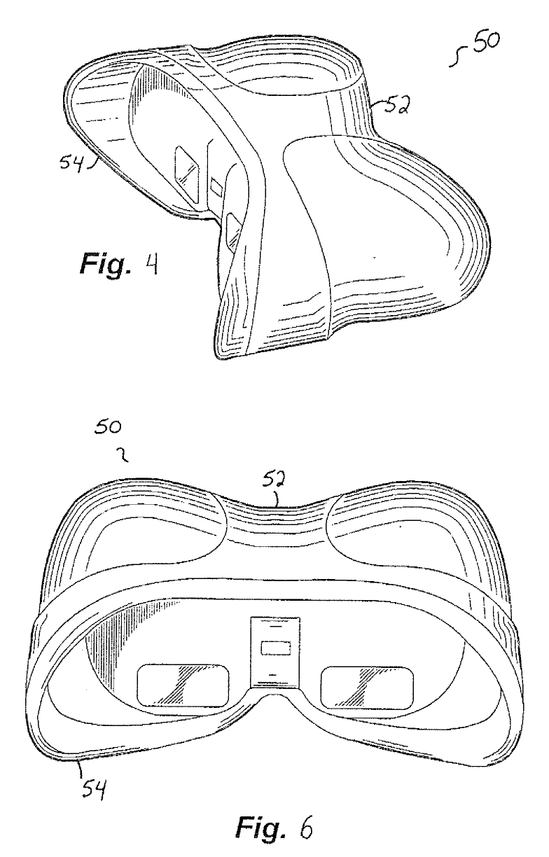

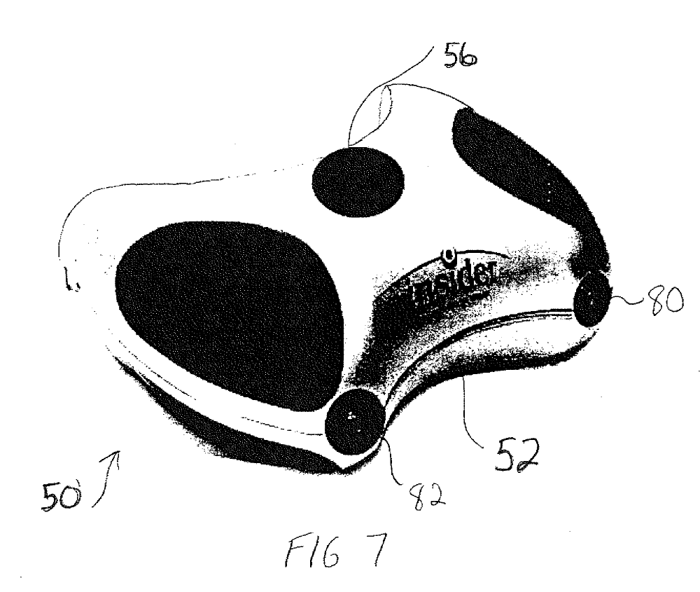

When a portable device, such as, for example, a handheld device 50 and 50′ (shown in FIGS. 4 through 7) is held to the user's face and the user looks into the lens 42, the magnified image is observed by the user 44. The user 44 observes the magnified image as much greater in size than the actual size of the image on the LCD 34, with the magnified image appearing to the user 44 to be located several feet in front of him or her. It should be noted that other embodiments of the image display system 30 may be employed without departing from the principles of the present invention. For example, in some embodiments, a single prism can be used as part of the image display system 30 or the LCD 34 may be held a distance from the user's face for viewing.

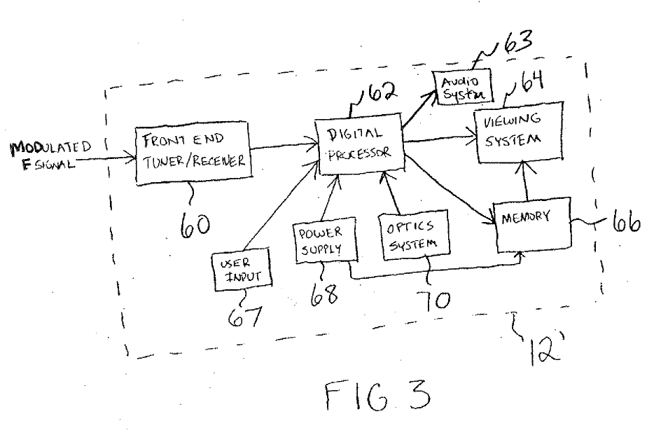

Other embodiments of a video/audio receiving system having additional or different components and performing additional or different functions are contemplated (e.g., enhanced viewing capabilities using binocular functions or video/audio storage capabilities). Specifically, in another exemplary embodiment, a video/audio receiving system 12′ as shown in FIG. 3 includes a front end tuner/receiver 60 provided for receiving a signal (e.g., modulated RF signal from an antenna within a receiving device) containing video signals 14 and/or audio signals 15, or a combination thereof. A processor, such as, for example, a digital processor 62 processes the received signal to provide video signals 14 defining images for display via a viewing system 64. The digital processor 62 may process the received signals to provide audio signals 15 defining audio for output by the handheld device 50 via an audio system 63 (e.g., output using speakers or to headphone connected to an audio jack). In one embodiment, the video/audio receiving system 12′ includes a memory 66 for storing video or audio content as described herein. A power supply 68 is also provided for powering the video/audio receiving system 12′, and specifically the digital processor 62 and memory 66. The video/audio receiving system 12′ also includes an optics system 70 for capturing images of an event, which are then processed by the digital processor 62 for display on the viewing system 64 or storage within the memory 66.

In particular, in one embodiment, the front end tuner/receiver 60 includes a digital video receiver/demodulator (i.e. tuner) that enables the video/audio receiving system 12′ to receive both digital video and audio signals transmitted, for example, over standardized television, Wireless Fidelity (WiFi), or other RF frequency bands. It should be noted that the received broadcast signal provides live and recorded video and audio content, and may include processor serial number specific enabling codes to indicate whether a particular video/audio receiving system 12′ is permitted to receive and display the broadcast signal (i.e. conditional access). Thus, conditional access allowing for both rental of devices containing the video/audio receiving system 12′ and/or pay per view functionality when devices are owned by a user 44 may be provided.

The digital video/audio output of the front end tuner/receiver 60 is provided to the digital processor 62, wherein the received signals are processed (e.g., conditioned) for display on the viewing system 64 or for storing in the memory 66 for later access and display. The front end tuner/receiver 60 is configured to receive transmissions having different transmission requirements, such as, for example, from 8 Virtual Side Band (8VSB) commercial television broadcasts, Coded Orthogonal Frequency Division Multiplex (COFDM) commercial television broadcasts and/or locally transmitted event content, such as provided using the system described in U.S. Pat. No. 6,578,203. Further, the front end tuner/receiver 60 also provides received audio signals to the digital processor for processing and outputting processed digital audio outputs for listening by a user or for storage.

The digital processor 62 is configured for processing video and audio signals 14 and 15 from the front end tuner/receiver 60. Further, the memory 66 and the optics system 70 are configured such that processed video and audio signals 14 and 15, which may include, for example, live view, real and recorded video and stored video and digital images, may be viewed using the viewing system 64 (e.g., via an LCD). The digital processor 62 interfaces directly with both the front end tuner/receiver 60 and the optics system 70 such that a user, via hardware and/or software controlled using a user input 67, can select the desired viewing or audio input. The user input 67, may include, for example, one or more buttons, knobs, dials, or other types of switches. It should be noted that these exemplary user inputs 67 may be interchanged, modified or replaced with other user inputs as desired or needed.

Additionally, the output of the digital processor 62, for example in the form of still images or continuous video, may be stored in the memory 66. The stored images/video may then be available, for example, for future viewing using the viewing system 64, or downloading to a printer or computer for further processing.

User control of the video/audio receiving system 12′ to control the operation of the digital processor 62 may be provided by a user input 67 (e.g., a standard NSEW four position button) provided as part of a handheld device. The user input 67, such as, for example, a multi-function button select system allows the user to select the mode of operation (e.g., broadcast video, binocular, digital camera with various telephoto settings, record and playback), as well as other features specific to a particular mode. For example, this may include telephoto options, video record time, start, stop, and rewind; image store (e.g., take a picture); store a continuous view (e.g., camcorder recording), etc. Additionally, the user input buttons may be used to control other functions, such as, for example, volume and video channel selection.

In one exemplary embodiment, the optics system 70 includes two fixed focus lenses each providing a signal to a charge coupled device (CCD). The CCD converts the focused optical signal into a digital signal that is processed by the digital processor 62 for display using the viewing system 64. In operation, the two fixed focus lenses enable, for example, a wide field view and a telephoto view, depending on the selection made by a user via the user input 67. For example, the optical zoom allows for a higher resolution zoom capability than an electronic zoom, in which a portion of the signal received by the CCD is expanded or “blown-up” to provide zoom capability. Thus, by including two lens/CCD subsystems, both optical and electronic zoom capabilities may be provided that allows for different settings (e.g., wide field (optical), telephoto 1 (digital from the wide field lens), telephoto 2 (optical telephoto), and telephoto 3 (digital from the optical telephoto lens)).

Viewing system 64 receives processed signals from the digital processor 62 or processed signals stored in the memory 66, and using “near-to-the-eye” optics, provides a user with an image (e.g., video image) of the processed signals. Using known displays and associated optics, a video image is provided such that a user appears to be viewing an image that is much larger than actually displayed. It should be noted that the viewing system 64 displays the output of the digital processor 62 based upon any of the video/audio/optical input sources.

The memory 66 may be provided using permanent memory, removable memory (e.g., DRAM), or a combination of both, such that a user may store single images and/or continuous video. The stored images and/or continuous video may be, for example, reviewed or replayed at the event to ensure that the contents stored is what is desired or needed by the user or to allow a user to view part of the event again (e.g., view a close call in a football game). In one embodiment, removable memory may be provided, such as, for example, a memory stick/cartridge that may be removed by a user after use at the event. Other interfaces may also be provided to access the images and/or continuous videos stored in the memory 66, such as a USB connector allowing for the downloading of the stored memory (e.g., captured video) to a computer.

In one exemplary embodiment, the power supply 68 includes a rechargeable battery, such as a rechargeable Li Ion or Li Polymer battery that may be permanent or removable from a device for recharging. The power supply 68 may also include a recharge outlet for recharging a battery while still in the device using a standard AC/DC power converter. The power supply 68 may also include a smaller replaceable battery (e.g. NiCad battery), that provides constant power to the memory 66 to ensure that a user's settings are not lost when main battery power falls below a predetermined operating level.

In the various embodiments of the present invention, the video/audio receiving systems 12 and 12′ are embodied within portable devices, and these various embodiments may include handheld devices 50 and 50′ as shown in FIGS. 4 through 7 and described in further detail herein. It should be noted that the handheld devices 50 and 50′ may be constructed having a housing unit or casing with each of the components shown and described in FIG. 1 or FIG. 3 contained therein. Using handheld devices 50 or 50′ for viewing video signals 14, a user's viewing experience may be enhanced. For example, when using the handheld devices 50 and 50′, a field view of the game from a camera located on another side of the stadium may be selected by a user, thereby allowing the user 44 to see a similar view as spectators located in that portion of the stadium. Further, in some embodiments, because the handheld devices 50 and 50′ may limit the user's peripheral view of the environment around him or her, the user 44 focuses on the view provided by the handheld devices 50 and 50′. In these embodiments, when the user 44 desires to view the event (e.g., game) directly, the user may quickly lower the handheld device 50 or 50′ so that the user's view of the game is not obstructed. It should be noted that the handheld devices 50 and 50′ may enhance a user's experience at any event, such as, for example, any sporting event or other event where a user 44 is unable to view the entire event (e.g., unable to see the entire racetrack).

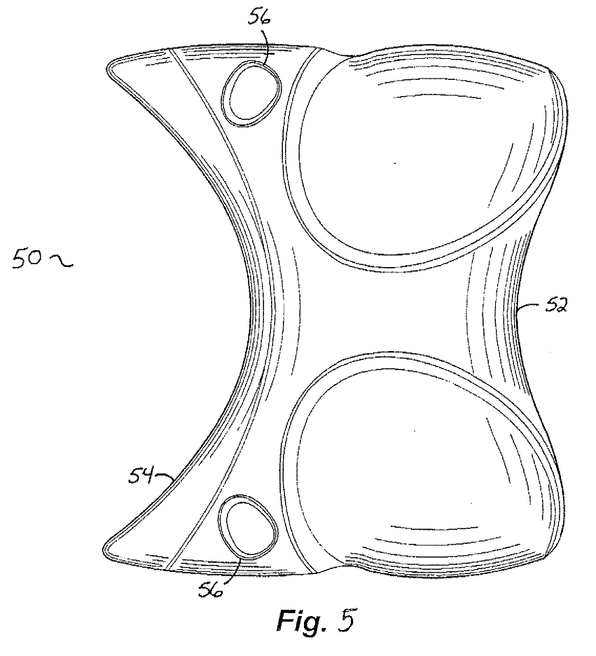

Furthermore, because the handheld devices 50 and 50′ are handheld, they are easily portable, and the user 44 may carry the handheld devices 50 and 50′ with him or her, and choose where he or she would like to view the images produced by the handheld devices 50 and 50′. For example, the user 44 may walk throughout a stadium with the handheld device 50 or 50′ in hand while intermittently viewing the images and hearing the sounds produced by the video/audio receiving system 12 or 12′. Further, by manipulating user input 67, such as, for example switches 56 as shown in FIGS. 5 and 7, the user 44 may control which video signals 14 are displayed and which audio signals 15 are produced by the video/audio receiving systems 12 or 12′. Accordingly, the handheld devices 50 and 50′ provide the user 44 more flexibility to observe and listen to an event, such as a sporting event, and results in a more enjoyable experience.

Different types of materials (e.g., part molded and part flexible material), casings or housings for the handheld devices 50 and 50′ may be employed to implement the various embodiments of the present invention. FIGS. 4 through 7 illustrate exemplary embodiments of such handheld devices 50 and 50′.

Specifically, as shown in FIG. 4, the handheld device 50 includes a main component 52 (e.g., molded housing), having the video/audio receiving system 12 or 12′ as shown in FIGS. 1 and 3, respectively, therein and used to provide an image to the user 44 as discussed herein. The handheld device 50 may also include a shroud 54 to block out ambient light. The shroud 54 is adapted to receive the user's forehead and allow the handheld device 50 to be engaged with the user's forehead while the user is wearing, for example, eye glasses or sunglasses. Further, as can be seen from FIG. 5, the shroud 54 is shaped and sized to completely cover the user's eyes, allowing the handheld device 50 to be held against the face and/or forehead comfortably and blocking ambient light. Also, and as a result, a space is provided between the eye position of the user 44 and the lenses 42 that are located in front of the user's eyes sufficient to accommodate the user's eyeglasses (e.g. about one inch or twenty-five millimeters).

As shown in FIGS. 5 and 7, one or more user inputs 67, such as, for example, switches 56 may be provided on the outside of the handheld device 50 or 50′ for activation by a user 44 when the handheld device 50 or 50′ is, for example, held to the user's face and/or forehead. The user inputs 67 (e.g., switches 56) may include, for example, a rocker switch used to provide control of a parameter that varies through a range, such as channel selection. Other functions or operations of the handheld device 50 or 50′ also may be controlled in a similar manner and include, but are not limited to, tint, hue or contrast of the image, image brightness, and volume control, among others. Other user inputs 67, such as, for example, a slider switch (not shown) on the bottom of the handheld device 50 or 50′ may also be provided, for example, to select among different choices or modes of operation. For example, the slider switch may be used to select left, right or no relative frame phasing, to select between the stereo and non-stereoscopic views, to select between TV viewer mode and binocular viewer mode, etc. Other controls and/or indicators also may be provided and mounted on various surfaces of the handheld devices 50 and 50′ as shown in the FIGS. 5 and 7.

As shown in FIG. 7, the video/audio system 12 or 12′ may be provided within a handheld device 50′, which includes a main component (e.g. housing) to provide an image to a user 44 as discussed herein. The handheld device 50′ may also include a user input 67 (shown in FIG. 3), such as the switch 56, which is shown in this embodiment as a four position toggle switch. In this embodiment, the handheld device 50′ also includes a first lens assembly 80 and a second lens assembly 82 provided as part of the optics system 70 to capture images of the event for processing as described herein.

Thus, in operation, and for example, using the video/audio receiving system 12′ in connection with the handheld device 50′, the front end tuner/receiver 60 may receive an RF modulated signal, such as an RF carrier signal having combined digital and audio images configured as video signals 14 and audio signals 15, which are provided to the digital processor 62. The digital processor 62 then processes or conditions the signals for display on the viewing system 64 or for audio output for listening by a user 44. Further, the processed or conditioned signals may be stored in the memory 66, such as, for example, as an optical picture or a continuous video. Further, the optics system 70, allows a user to view a magnified view of an event using the viewing system 64. Essentially, the optic system 70 provides a selectable binocular type functionality to the handheld device 50′. For example, using the user input 67, such as switches 56, a user 44 may select a wide angle view or telephoto view for display using the viewing system 64. Alternatively, the user 44 may select a different mode of operation wherein different live views of the event may be viewed. The user 44 also may view content not related to the event being attended as described herein.

Thus, a user with an authorized handheld device 50 or 50′ (e.g., proper serial number transmitted indicating a paid subscription to allow access to audio and video content) may access video and audio content at an event. Specifically, using the user input 67, such as switches 56, a user may select between different locally transmitted video feeds, for example on different channels, to view different angles or portions of the event. Further, a user may view a live television broadcast of the event or other commercially broadcast channels. It should be noted that the video/audio receiving system 12 or 12′ may be configured such that an initial search is performed to determine the channels that may be accessed by user for viewing on the viewing system 64. It should also be noted that the video and audio content accessed at an event is not limited to images and sounds of the event being attended. For example, event content may include, for example, images and sounds from other live events (e.g., a football game occurring simultaneously), live news, weather or sports scores, movies, television shows and/or cartoons, venue information such as, for example, traffic updates, Internet access, interactive contests or other gaining.

In one embodiment, a user input 67 (e.g., slider switch) on the bottom side of the handheld device 50 or 50′ may be used to select a mode of operation. For example, the handheld device 50′ may provide the following general modes of operation: a video or digital TV viewer mode, a radio mode, a binocular viewer mode, a digital camera mode and a camcorder mode. Each of these modes may be selected using a user input 67, for example, the slider switch. Thereafter, when a mode is selected and within each of the modes, another user input 67 (e.g., switch 56 or toggle button) may be used to select and operate different functions within that mode. For example, in the digital TV viewer mode, toggle buttons may be used to control volume and channel selection. In the binocular mode, the toggle buttons may be used to select between the different types of enhanced or magnified viewing. In the digital camera mode, the toggle buttons may be used to select between a normal and zoom mode and for capturing still images. In the camcorder mode, the toggle buttons may be used to select between the various operation functions for continuous video operation, such as, slow motion, pause, rewind or fast forward.

Thus, a user 44 may be provided with different video and audio content associated with an event at which the user is attending, another event of interest, or content of interest to the viewer (e.g., business news, cartoons, etc.). Further, a user 44 may select different options for viewing the event (e.g., binocular viewing) or store some or all of the event content (e.g., store still images of the event).

It is not necessary for the user 44 to keep the handheld device 50 or 50′ within the confines of the event (e.g., within the stadium). For example, the video and audio signals 14 and 15 may be transmitted via satellites and/or communication networks to various locations around the world, and the user 44 may select the view he or she prefers the most from a remote location capable of receiving a video signal 14 and/or audio signal 15.

The handheld device 50 or 50′ also may be retrieved from the user 44 after the user 44 is finished viewing the event so that the handheld device 50 or 50′ can be provided to another spectator for another event, for example, at another stadium. Each user 44 may be charged a usage fee for use of the handheld device 50 or 50′, or alternatively, a user may purchase the handheld device 50 or 50′ and pay a monthly subscription fee for use of the device. In some of the various embodiments, payment of the fee may be required before the user 44 is provided with the handheld device 50 or 50′. In other embodiments, the handheld device 50 or 50′ may receive information, via video and audio signals 14 and 15, or otherwise, indicating whether the handheld device 50 or 50′ is authorized to produce sounds and images defined by the signals (e.g., authorized serial number transmitted to the video/audio system 12 or 12′). In this embodiment, the handheld device 50 or 50′ is configured to produce images and sound only when authorized, with authorization information (e.g., authorization code unique to a handheld device 50 or 50′) transmitted from an audio/video transmitter using an audio/video system such as described in U.S. Pat. No. 6,578,203, to the handheld device 50 or 50′, only when the user 44 of the handheld device 50 or 50′ has provided proper payment.

It should also be noted that various modifications and changes may be made to the various embodiments of the present invention. For example, the signal interface 18 and front end tuner/receiver 60 may be constructed using wireless fidelity WiFi hardware and software for receiving transmission of content provided on different bands (e.g., 2.4 GHz, 5.8 GHz, or 10 GHz), instead of or in addition to a UHF TV frequency band (e.g., 400 MHz-800 MHz). Thus, the handheld device 50 or 50′ may operate and receive content via lower UHF frequency bands or higher WiFi bands as desired or needed.

Further, use of WiFi also allows for passive and active two-way communication. For example, in operation using passive communication, automatic “device to device” communication is transparent to a user 44. This communication may include, for example, communication of conditional access codes, collection of statistical data regarding viewing habits, etc. With respect to using active communication, interactive communication may be provided in which the user 44 actively makes requests for information, purchases, etc., which requests are conveyed to the system for further action. This also may include, for example, accessing the Internet or email. Thus, different types of data embodied in different signals, instead of or in addition to the video and audio signals 14 and 15, may be implemented within the various embodiments of the present invention (e.g., transmitted and received by the handheld device 50 or 50′).

Further, it should be noted that using the video/audio system 12 or 12′ in connection with the handheld devices 50 or 50′ allows for operation of a venue based transmission system in which signals from a production facility not located at the event may be provided. For example, the signals, such as the video and audio signals 14 and 15, may be available via the Internet or satellite with a transmission system operated and monitored remotely from the production facility. Further, and for example, at least one of the video signals 14 and one of the audio signals 15 may be transmitted as a single combined signal from an audio/video system such as described in U.S. Pat. No. 6,578,203 and that is provided at a production facility not located at the event. Thereafter, transmission is provided via multiple WiFi modes at the event. The production facility may receive its content via satellite download.

While the invention has been described in terms of various specific embodiments, those skilled in the art will recognize that the invention can be practiced with modification within the spirit and scope of the claims.

What is claimed is:

1. A portable wireless handheld device to be used at an event by a user while watching the event live, the portable wireless handheld device comprising:
a receiver to receive video content transmitted wirelessly to the receiver, the video content being generated by a plurality of cameras located at the event, the video content relating to the event;
a user interface having inputs to permit a user to select the video content from at least one of the plurality of cameras and having an input to permit the user to select, for storage in the device, a user-designated portion of the video content from the selected one of the plurality of cameras;
a processor selectably operated by a user to select video content from at least one of the plurality of cameras;
a display to display video content from at least one of the plurality of cameras selected by the user, wherein the receiver is configured to receive the video content while at the event and where the event is occurring, thereby permitting the user to carry the portable wireless handheld device about the event and choose where to view the video content selected by the user while roaming at the event during the event; and
a memory component to store a user-designated portion of the video content, wherein the user-designated portion of the video content to be stored in the memory component is selected and entered by the user through the user interface.

2. The portable wireless handheld device of claim 1, wherein the receiver is configured to receive audio signals relating to the event, and further comprising an audio component configured to provide event content for listening based upon at least one of the audio signals selected by a user.

3. The portable wireless handheld device of claim 1, wherein the memory component is controlled by the user interface to access and replay the stored user-designated portion of the event related video content on the display, thereby permitting the user to review again and again, as desired, the stored user-designated portion of the video content independent of new live video content received by the receiver.

4. The portable wireless handheld device of claim 1, wherein the memory component is a removable memory module configured to allow for downloading of the stored user-designated portion of the event content to an external device.

5. The portable wireless handheld device of claim 1, wherein the processor operates in a plurality of modes, wherein the plurality of modes comprises each of a video viewer mode, a digital camera mode and a camcorder mode.

6. The portable wireless handheld device of claim 1, further comprising an optics system provided as part of a housing to capture images of the event when directed toward the event.

7. The portable wireless handheld device of claim 1, further comprising an optics system provided as part of a housing to capture images of the event when directed toward the event, the optics system comprising a charge coupled device and being configured to provide a plurality of magnified modes of operation.

8. The portable wireless handheld device of claim 1, wherein the display is configured for viewing by a user when engaged with the user's face.

9. A portable wireless handheld device to be used at a local event by a user while watching the local event live, the portable wireless handheld device comprising:
a receiver to receive video content transmitted wirelessly to the receiver, the video content being generated by a plurality of cameras located at the local event, the video content relating to the local event;
an optics system that, when directed toward the local event, provides binocular functionality to produce magnified video content separate and independent from the video content produced by the plurality of cameras and received by the receiver;
a user interface having inputs to permit a user to select the video content from at least one of the plurality of cameras and the magnified video content from the optics system;
a processor selectably operated by a user to select video content from at least one of the plurality of cameras; and
a display to display video content from at least one of the plurality of cameras selected by the user and to display the magnified video content from the optics system, wherein the receiver is configured to receive the video content while at the local event and where the local event is occurring, thereby permitting the user to carry the portable wireless handheld device about the local event and choose where to view the video content selected by the user while roaming at the local event during the local event.

10. The portable wireless handheld device of claim 9, wherein the processor is configured to provide conditional access to the event content based upon a unique access code.

11. The portable wireless handheld device of claim 9, further comprising a user input selectably operable by a user to control the images and sounds provided to the display and audio system.

12. The portable wireless handheld device of claim 1, wherein the user interface permits the user to selectively store single individual images, to be reviewed again and again on the display as desired by the user.

13. The portable wireless handheld device of claim 1, further comprising an optics system that, when directed toward the event, provides binocular functionality, the display displaying video content from the receiver when in a video viewer mode and a magnified view of the event as detected by the optics system when in a binocular mode.

14. The portable wireless handheld device of claim 1, further comprising an optics system that, when directed toward the event, provides binocular functionality, the display displaying a magnified view of the event as detected by the optics system when in a binocular mode, the user interface including inputs to select between different magnification levels at which the magnified view of the event is presented on the display.

15. The portable wireless handheld device of claim 1, further comprising an optics system to detect user-controlled video content separate and independent from the video content produced by the plurality of cameras and received by the receiver.
